(19) United States
(12) Patent Application Publication
(10) Pub. No.: US 2011/0119241 A1
(43) Pub. Date: May 19, 2011

(54) ACTIVE SEARCH ENGINE AND METHOD THEREOF

(76) Inventor: Zhenzhou Ge, San Jose, CA (US)

(21) Appl. No.: 12/618,531

(22) Filed: Nov. 13, 2009

(51) Int. Cl. G06F 17/30

(52) U.S. Cl. 707/706; 707/E17.108

(57) ABSTRACT

An active search engine provided on a server includes (a) a database; (b) a search engine which receives a search criterion and searches the database based on the search criteria to retrieve search results responsive to the search criterion; and (c) an interface program running on the server which (a) receives a connection request from an application program running on an external computer and establishes the connection with the application program accordingly; (b) receives from the application program the search criterion; (c) repeatedly (i) provides the search criterion to the reverse search engine and receives from the reverse search engine the responsive search results; and (ii) formats and provides the responsive search results to the application program; and (e) maintains the connection with the application program. An associated method for the active search engine is also disclosed.

### BACKGROUND OF THE INVENTION

1. Field of the Invention

The present invention relates to methods for providing timely information updates to users. In particular, the patent invention relates to methods for providing updates of search results by an active search engine.

2. Discussion of the Related Art

In a conventional search paradigm, a user of a search engine prepares a search string using an application (popularly known as a “web browser”) and sends the search string to a search engine by initiating a connection under a conventional internet communication protocol, such as the hypertext transfer protocol (“http”). Typically, the search engine returns the results of the search over the connection to the user and terminates the connection.

General purpose search engines, such as those provided by providers such as Google or Yahoo, are used to access all kinds of subject matters. Typically, because of the vast number of web sites covered, the content database from which the search engine draws its result can be updated only relatively infrequently (e.g., twice a day). For some time-sensitive applications, e.g., searching for new pages advertising job vacancies, the infrequent update is undesirable.

As an alternative to general purpose search engines, special purpose or “vertical” search engines have been developed. Examples of vertical search engines include the services provided by Indeed.com and ClassifiedAds.com. A vertical search engine specializes in searching a limited set of subject matters (e.g., job postings). Because the searched subject matters are limited, the content database may be updated more frequently and provides the user more timely information than general purpose search engines. To take advantage of the more timely information, the user must query the vertical search engine equally frequently. Without querying the vertical search engine, the timely updated results do not reach the user. Human users are known to be notoriously passive (i.e., they are reluctant to repeat the search at a high frequency). Especially because only a proportionally small number of results are new, users are often discouraged to repeat the same search at a higher frequency. For advertisers, the low frequency users repeat their searches means less number of accesses to their advertised pages and diminished effectiveness of their advertisements. As a result, search service providers who derive revenue from users accessing linked pages reported in search results receive less revenue.

### SUMMARY

According to one embodiment of the present invention, an active search engine provided on a server includes (a) a database; (b) a search engine which receives a search criterion and searches the database based on the search criteria to retrieve search results responsive to the search criterion; and (c) an interface program running on the server which (a) receives a connection request from an application program running on an external computer and establishes the connection with the application program accordingly; (b) receives from the application program the search criterion; (c) repeatedly (i) provides the search criterion to the search engine and receives from the search engine the responsive search results; and (ii) formats and provides the responsive search results to the application program; and (e) maintains the connection with the application program.

According to one embodiment, the active search engine provides the search criterion to the search engine periodically.

According to one embodiment, the responsive search results are provided to the application program when an amount of additional or changed information, relative to a previous time the responsive search results are provided to the application program, exceeds a threshold. According to one embodiment, the interface program formats the responsive search results to provide only additional or changed information, relative to a previous time the responsive search results are provided to the application program,

According to one embodiment, the interface program includes in the responsive search results to provide tracking information in embedded links, so as to credits to be given to the active search engine when one or more of the embedded links are used to access related web pages.

According to one embodiment, the database is updated at least as frequently as the interface program provides responsive results to the application program. A second search engine may be used to search web pages outside of the server to provide updates to the database. Alternatively, an external service provider may provide updates to the database.

According to one embodiment, a method for providing the active search engine on a server, includes (a) receiving into an interface program running on the server a connection request from an application program running on an external computer; (b) establishing the connection with the application program in accordance with the connection request; (c) receiving from the application program a search criterion; (d) repeatedly (i) providing the search criterion to a search engine, which uses the search criterion to search a database; (ii) receiving from the search engine search results responsive to the search criterion; and (ii) formatting and providing the responsive search results to the application program; and (e) maintaining the connection with the application program.

The present invention is better understood upon consideration of the detailed description below in conjunction with the accompanying drawings.

### BRIEF DESCRIPTION OF THE DRAWINGS

FIG. 1 shows search system 100, which includes active search engine 150, in accordance with one embodiment of the present invention.

### DETAILED DESCRIPTION OF THE PREFERRED EMBODIMENTS

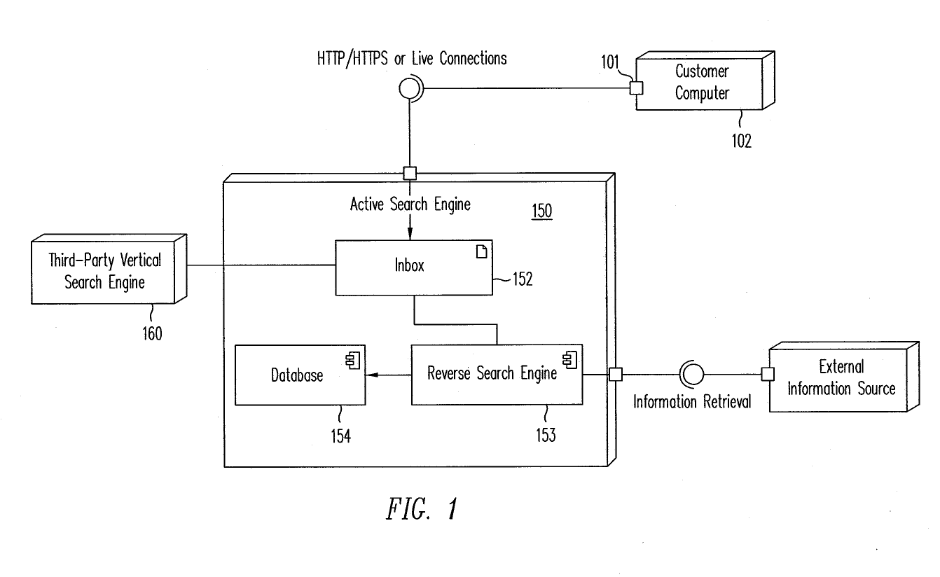

The present invention provides an active search engine that delivers time-sensitive search results to a user computer or mobile device based on saved search criteria. FIG. 1 shows search system 100, which includes active search engine 150, in accordance with one embodiment of the present invention. In this detailed description, the present invention is illustrated by an application which allows a user to search for job listings. However, the present invention may be used also for searching other types of time-sensitive information.

As shown in FIG. 1, user application 101 runs on a user's computer 102 as a desktop or web application. Through user application 101, the user specifies one or more search criteria (e.g., search phrases “system analyst,” “application programmer” and “J2EE”). User application 101 initiates a connection to active search engine 150 (which runs on server 151) and provides active search engine 150 with the search criteria. User application 101 may be, for example, a browser or a customized application program. In one embodiment, unlike conventional and vertical search engines, active search engine 150 does not terminate the connection with user application 101 after delivering the search results. Rather, active search engine 150 maintains a connection with user application 101 until user application 101 closes the connection. Suitable connection protocols are the widely supported protocols for implementing “push technology” or “server push.” Alternatively, connection with the server may be established or re-established at selected time intervals using for example, “http/https” protocols, which are disconnected after the server responds to the client. Context is re-established at reconnection using a “cookie” which is stored at a location accessible by user application 101 on the user device.

With the connection between user application 101 and active search engine 150 provides user application 101 updates of the search result at a predetermined frequency (e.g., every 15 minutes) based on a timeliness requirement designed for the subject matter of the search. Although only user application 101 is shown connected to active search engine 150, it is to be understood that active search engine 150 may service a large number of user applications that are similar to user application 101 at the same time.

As shown in FIG. 1, active search engine 150 may include “inbox” 152, reverse search engine 153, and database 154. Inbox 152 interfaces with both user application 101 and external vertical search engine 160. Specifically, inbox 152 receives the search criteria from user application 101. When job listings are received into or updated in database 154 or upon user request, reverse search engine 153 retrieves from database 154 search results responsive to the search criteria. Inbox 152 also returns to user application 101 responsive search results from a cache of search results. The cache of search results in inbox 152 are obtained from searching the internet using a conventional vertical search engine according to search criteria of interest. Typically, results from a search includes only information in abbreviated form. For example, one vertical search engine provides only a job title, a “clickable” link to the webpage where the job posting appears and some basic information. Detailed information (e.g., a job description) is not provided. Job listing objects in database 154, typically provided by a external service provider or information source, is more complete.

As shown in FIG. 1, job listings in database 154 are updated by the external data source periodically, which may be at a higher or lower frequency than the frequency at which search results are provided to user application 101. Vertical search engine 160 returns to the results cache of inbox 152 based on search phrases provided by inbox 152. In one embodiment, inbox 152 refreshes the results cache by accessing vertical search engine 160 after a time interval determined by the age of the search results (e.g., the search results may be deemed “too old” after 30 minutes). For example, user application 101 may request a new search or an update of results to the search phrase “Java Programmer, San Jose, CA.” If the requested information is found in the results cached and is still deemed fresh (e.g., less than 30 minutes old) at the time of the request, inbox 152 returns to user application 101 the results from the cached information. Otherwise, i.e., the information is not found cached, or is deemed too old, inbox 152 initiates a new search at vertical search engine 160 to refresh the results cache. In addition, inbox 152 returns to user application 101 the responsive results returned by reverse search engine 153 from information in database 154.

When a new content object (e.g. a job posting) enters the system from external information source, reverse search engine 153 immediately delivers the content object to inboxes, if a match can be identified between the new content object and the search phrases for those inboxes. Reverse search engine 153 is so named because, unlike a conventional search engine, which typically applies a small number of search phrases to a very large number of content objects, a reverse search engine applies a relatively large number of search phrases on a single content object. Results from inbox 152 have no artificial delay, other than the time interval used by user application 101 to query active search engine 150. Inbox 152 then returns the search results to user application 101 after suitable formatting. Such formatting may include, for example, inserting tracking information which allows advertisers to provide credit to active search engine 150 when a user of user application 101 “clicks on” a link embedded in the search results returned to user application 101. In some embodiments, only results that are either not present or changed from the previous search are return. In other embodiments, entire updated search results are returned.

In one embodiment, rather than strictly periodically, user application 101 is also provided updates when the number of new search results or changed search results exceeds a predetermined threshold.

In this manner, a user needs only specify his/her search criteria only once and receives updates in a timely manner. For advertisers, the higher frequency users receive search results mean a greater number of accesses to their advertised pages and increased effectiveness of their advertisements. As a result, search service providers who derive revenue from users accessing linked pages reported in search results receive higher revenue.

The above detailed description is provided to illustrate specific embodiments of the present invention and is not intended to be limiting. Numerous variations and modifications within the scope of the present invention are possible. The present invention is set forth in the following claims.

I claim:

1. An active search engine provided on a server, comprising:
a database;
a reverse search engine which receives a search criterion and searches the database based on the search criteria to retrieve search results responsive to the search criterion;
an interface program running on the server which (a) receives a connection request from an application program running on an external computer and establishes the connection with the application program accordingly; (b) receives from the application program the search criterion; (c) repeatedly (i) provides the search criterion to the reverse search engine and receives from the reverse search engine the responsive search results; and (ii) formats and provides the responsive search results to the application program; and (e) maintains the connection with the application program.

2. An active search engine as in claim 1, wherein the search criterion is provided to the search engine periodically.

3. An active search engine as in claim 1, wherein the responsive search results are provided to the application program when an amount of additional or changed information, relative to a previous time the responsive search results are provided to the application program, exceeds a threshold.

4. An active search engine as in claim 1, wherein the interface program formats the responsive search results to provide only additional or changed information, relative to a previous time the responsive search results are provided to the application program,

5. An active search engine as in claim 1, wherein the interface program includes in the responsive search results to provide tracking information in embedded links, so as to credits to be given to the active search engine when one or more of the embedded links are used to access related web pages.

6. An active search engine as in claim 1, wherein the database is updated at least as frequently as the interface program provides responsive results to the application program.

7. An active search engine as in claim 6, wherein an external service provider updates the database.

8. An active search engine as in claim 1, further comprising a cache for storing search results of searching webpages outside of the server, wherein the interface program further provides the application program search results extracted from the cache responsive to the search criterion.

9. An active search engine as in claim 8, further comprising a second search engine to refresh the cache.

10. An active search engine as in claim 8, wherein the cache is refreshed by an external vertical search engine.

11. A method for providing an active search engine on a server, comprising:
receiving into an interface program running on the server a connection request from an application program running on an external computer;
establishing the connection with the application program in accordance with the connection request;
receiving from the application program a search criterion;
repeatedly (i) providing the search criterion to a reverse search engine, which uses the search criterion to search a database; (ii) receiving from the reverse search engine search results responsive to the search criterion; and (ii) formatting and providing the responsive search results to the application program; and
maintaining the connection with the application program.

12. A method as in claim 11, wherein the search criterion is provided to the search engine periodically.

13. A method as in claim 11, wherein the responsive search results are provided to the application program when an amount of additional or changed information, relative to a previous time the responsive search results are provided to the application program, exceeds a threshold.

14. A method as in claim 11, wherein the interface program formats the responsive search results to provide only additional or changed information, relative to a previous time the responsive search results are provided to the application program,

15. A method as in claim 11, wherein the interface program includes in the responsive search results to provide tracking information in embedded links, so as to credits to be given to the active search engine when one or more of the embedded links are used to access related web pages.

16. A method as in claim 11, wherein the database is updated at least as frequently as the interface program provides responsive results to the application program.

17. A method as in claim 16, wherein an external service provider updates the database.

18. A method as in claim 11, further comprising storing in a cache search results from searching webpages outside of the server, and further providing the application program search results extracted from the cache responsive to the search criterion.

19. A method as in claim 18, further comprising refreshing the cache using a search engine within the server.

20. A method as in claim 18, further comprising refreshing the cache using an external vertical search engine.
